(19) United States
(12) Patent Application Publication
(10) Pub. No.: US 2012/0097809 A1
(43) Pub. Date: Apr. 26, 2012

(54) Collapsible Adjusting Funnel Stand

(76) Inventor: Barbara Rose Carlson, Ventura, CA (US)

(21) Appl. No.: 13/279,310

(22) Filed: Oct. 23, 2011

Related U.S. Application Data
(60) Provisional application No. 61/406,147, filed on Oct. 24, 2010.

(51) Int. Cl. F16M 11/38

(52) U.S. Cl. 248/125.8

(57) ABSTRACT

A collapsible adjusting utility stand that folds flat for convenient storage and deploys quickly. The stand can be used to stabilize one object over a base surface and hold a second object in a desired orientation relative to the base while adjusting and fixing the vertical elevation of the second object. We describe in detail an embodiment configured as a collapsible adjusting funnel stand.

### CROSS-REFERENCE TO RELATED APPLICATIONS

The present application claims the priority date of a prior filed provisional patent application No. 61/406,147 and an official filing date of Oct. 24, 2010 and which discloses substantially similar matter as described herein.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Instances arise where it is desirable to hold an object fixed in orientation relative to another object while adjusting the distance between them vertically. When the task requires more than two hands or the relative orientation must be maintained over a long period, a device to assist in performing these functions would prove useful. One embodiment of such an aid configured to hold funnels of varying dimensions in an approximately vertical orientation over receiving containers of varying dimensions at desired elevations is described herein.

Before explaining the disclosed embodiment of the present invention in detail it is to be understood that the invention is not limited in its application to the details of the particular arrangement shown, since the invention is capable of other embodiments. Also, the terminology used herein is for the purpose of description and not of limitation.

With rising interest in cost cutting and reducing the volume of waste going into landfills, a growing number of household products in liquid and granular form are available in large bulk containers which can be used to refill and re-use smaller dispenser-size containers. These containers come in a wide variety of sizes and shapes. The funnel is a familiar tool that aids in the transfer of fluids or granular solids between two containers.

One person trying to use an ordinary funnel encounters an equally familiar set of problems, particularly if the receiving container is lightweight and tall with a narrow base, and the fluid in transfer is viscous. The stack, including the funnel and receiving container, becomes top heavy and prone to tipping. Downward pressure on the funnel spout tends to exacerbate the problem by sealing the spout against the edge of the container opening, preventing the escape of displaced air. Material can quickly build up in the funnel and spill over the edge or tip the stack.

One solution would be to recruit an assistant to steady and position the receiving container upright with one hand while holding the funnel suspended over the container opening with the other in a generally vertical orientation along the axis of the spout. The assistant would then raise or lower the funnel vertically until the spout projected down into the container opening a sufficient distance to prevent spillage while leaving a gap around the opening to allow displaced air to escape. The assistant would then hold that position until the operation was complete, maybe long enough to allow a nearly empty container inverted in the funnel to drain the last of its contents.

A device that allows one person to position a receiving container with one hand while adjusting and fixing the elevation of a funnel with the other should possess an additional set of attributes to see widespread use. The device should collapse for convenient storage and be quick to set up and easy to adjust. It should not obstruct the user's view of the funnel spout and receiving container opening where spills are more likely to occur, either during the act of adjustment or the process of material transfer. The device should be easy to clean and maintain. To have the broadest possible application it should accommodate the wide array of funnel dimensions available and adjust to work with a wide array of container shapes.

Vertically adjusting funnel holders that extend the vertical supporting member using tubes or sliding arms are not conducive to operation using only one hand due in part to frictional resistance between the relatively large surface areas in contact between fixed and moving parts. These approaches also generally require the user to position the support at elevation with one hand while fixing the position with the other. Sliding arms and telescoping tubes add weight to the moving parts and deny access of the funnel holder to a good portion of the vertical range spanned by the vertical support member as a whole.

Approaches that employ sliding collars that ride on fixed length posts can avoid some of these problems but are still prone to binding and fouling, can be difficult to clean, and generally require two hands for changing and fixing elevation. Examples of adjusting funnel stands include: U.S. Pat. No. 545,915; U.S. Pat. No. 1,045,622; U.S. Pat. No. 2,324,655; U.S. Pat. No. 2,783,010; and U.S. Pat. No. D. 341,520. There remains a need for a convenient replacement for the often-scarce assistant that will allow one person to position and stabilize an object on a base with one hand while fixing the orientation and height of another object above it with the other, and then leave both hands free to complete the task.

### SUMMARY

We disclose an innovative collapsible adjusting utility stand that allows the user to steady, position, and secure an object on a base surface with one hand; and with the other hand vertically adjust and fix the elevation of a second object over the base while maintaining the second object in a desired orientation. The described utility stand allows the user to adjust and hold the orientation of the upper object in position relative to the base and then maintain that orientation while moving within nearly the full range of the vertical space occupied by the utility stand. Reduced weight of the moving parts and minimized contact surface area between fixed and moving parts to frictional resistance facilitate ease of operation. Only one hand is needed to make the vertical adjustment and fix the elevation.

We describe and illustrate an embodiment of the invention configured to hold ordinary funnels in a wide range of sizes in a generally vertical orientation along the axis of the spout above receiving containers in a wide range of dimensions at the desired vertical elevation. The stand in this embodiment includes a base and a slotted vertical carrier that serves as support and guide for a sliding vertical adjustment assembly that travels vertically along the carrier. An object holder configured as a funnel holder connected to the vertical adjustment assembly includes a frame that accepts a set of interchangeable funnel support plates with circular cutouts of varying diameters to accommodate a range of funnel sizes.

The base, the holder and the holder brace fold parallel with the vertical carrier for compact storage. The user opens the base to a right angle with the carrier and locks it in place with a sliding collar on the side hinged base braces. A funnel works best when held in a generally vertical orientation along the axis of the spout, so the sliding vertical adjustment assembly and object holder in this embodiment are configured to maintain a funnel support plate in a generally horizontal orientation.

A face plate on the vertical adjustment assembly is adjusted by rotating the face plate around a pivot mounted to a back plate and fixed in the selected position with an adjusting knob on a threaded shaft projecting from the back plate and inserted in a curved slot in the face plate. For a funnel holder, the face plate is normally adjusted and fixed in position to maintain the holder in a generally horizontal lateral orientation. The bracing member for the holder in this embodiment is fixed at the proper length to also maintain a generally horizontal orientation from front to back when the holder is opened and the end of the brace opposite the hinge engages with a slotted opening in the face plate. For applications other than holding funnels, embodiments of the holder brace can vary in length or be made extensible to allow the holder to be fixed at different positions of rotation around the hinged holder connection.

The user selects a funnel with dimensions that allow the funnel spout to project into the receiving container opening without creating a seal around the opening, and then chooses a funnel support plate with a circular cutout diameter that best fits the upper portion of the funnel while allowing most of the funnel body to hang below the support plate. The support plate slides into a notched frame in the holder. If the base of the receiving container is so wide that it contacts the vertical carrier, the funnel support plate can hang a distance off the front end of the holder to reach the container opening and still adequately support the funnel. Using a set of support plates made of a stiff transparent material and placing the vertical adjustment handle on the back side of the vertical carrier minimizes visual obstruction of the funnel spout and the receiving container opening during vertical adjustment and the process of material transfer.

With the chosen funnel in place, the user loosens the threaded adjustment handle on the back side of the vertical carrier and moves the vertical adjustment assembly to allow the receiving container to fit under the funnel on the base platform. The user places the receiving container on the base and positions it approximately under the funnel spout, and then moves the vertical adjustment assembly down while positioning the receiving container so that the funnel spout projects the desired distance into the container opening. When the desired height is reached the user tightens the vertical adjustment handle to fix the assembly at elevation.

If the funnel spout projects a sufficient distance into the container opening to limit lateral movement by the top of the receiving container it will decrease the likelihood of tipping the container over. In many cases that alone will provide sufficient stability for the receiving container. If the only available funnel is a poor fit with the receiving container opening or if a container is to be left inverted in the funnel to drain for a long period where the stand might get jostled, it may be desirable to stabilize the base of the container as well.

The user can stretch an elastic band between upright posts across the center of the base to provide additional stability for the receiving container. Placing the receiving container inside the stretched band will still allow the user to move the container front to back while limiting lateral movement of the base of the container once released in the final position. Resistance to movement by the container will be determined in part by the surface materials and textures of the stabilizing band and container, and the tension of the stretched band. Other embodiments that clamp or otherwise stabilize a container or other object relative to the base and still fold flat for storage can be used.

The choice of materials and surface textures used to construct a collapsible adjusting utility stand and the desired application will inform embodiments of the vertical carrier and vertical adjusting assembly that contribute to ease of operation. A vertical carrier with one or more vertical slots as the sole support and guide allows embodiments of the vertical adjusting assembly that eliminate much of the bulk, weight, and frictional resistance found in sliding or telescoping arms. Movement from side to side and rotation in the plane of the vertical carrier can be limited by four relatively small contact sites; in the embodiment described herein by the either side of two shafts contacting the edges of a single slot. Movement from front to back and rotational movement by the vertical adjusting assembly in the described embodiment can be limited by interactions between relatively small surfaces acting against both faces of the vertical carrier adjacent to the slot. The latter function could also be accomplished through minimal surface contact with grooves placed along the edges of the slot or slots.

Wheels or rollers may be employed where frictional resistance to movement would be otherwise unacceptable. The embodiment of the vertical adjustment assembly illustrated herein for the funnel holder configuration employs a bottom roller that sits approximately flush with the back side of the back plate. As the adjustment handle is loosened from the back side of the vertical carrier, the weight of the holder will tend to tip the adjustment assembly forward at the top and bring the roller in contact with the face of the vertical carrier. Wheels or rollers might also be spring loaded to assist in holding surfaces of moving parts away from fixed surfaces while the vertical adjustment assembly is moving.

A number of embodiments of a simple adjusting handle or grip that can be operated with one hand to fix the vertical adjusting assembly at elevation relative to the vertical carrier are possible. The embodiment described herein uses a threaded handle to compress the assembly back plate and an adjustment handle washer against the vertical carrier. This configuration has the further advantage of not marking up the face of the carrier, unlike many stands with fixed length vertical members that rely on set bolts that tighten directly against a vertical member. These and other features, aspects, and advantages of the present invention will become better understood with reference to the following description and claims.

### BRIEF DESCRIPTION OF THE SEVERAL VIEWS OF THE DRAWING

FIG. 1 shows a perspective view of a collapsible adjusting utility stand configured to hold funnels with the base and holder deployed in the “open” position, a stabilizer band installed across the base, the holder set to a generally horizontal configuration, and a funnel support plate with funnel ready to install in the holder;

FIG. 2 shows a sectional view of a collapsible adjusting utility stand configured as a funnel holder cut down the center through the slot from front to back along hashed line II in FIG. 1, as viewed from the side;

FIG. 3 shows a side view of a collapsible adjusting utility stand configured as a funnel holder folded in the “closed” position;

FIG. 4 depicts a front view of a collapsible adjusting utility stand configured as a funnel holder showing the stand in the “open” position with a nearly transparent plastic receiving container secured on the base platform by an elastic stabilizing band and a funnel support plate holding a nearly transparent funnel fixed at a desired vertical elevation;

FIG. 5 depicts a back view of a collapsible adjusting utility stand configured as a funnel holder showing the adjustment handle and guide shaft in the vertical carrier slot, and the rear stabilizing post with a stabilizing elastic band installed as in FIG. 1;

FIG. 6 depicts a top view of a collapsible adjusting utility stand configured as a funnel holder in the open position showing a funnel support plate ready to install;

FIG. 7 shows a front view of a vertical adjustment assembly for a collapsible adjusting utility stand; and

FIG. 8 shows a perspective view of the back side of the vertical adjustment assembly of FIG. 7.

### DETAILED DESCRIPTION

The present invention will now be described with reference to the accompanying figures. For purposes of the description hereinafter, the terms “right”, “left”, “top”, “side,” “front”, “back” and derivatives thereof shall relate to the invention as it is oriented in the drawing figures. However, it is to be understood that the invention may assume various alternative variations, except where expressly specified to the contrary. It is to be understood that the specific apparatus illustrated in the attached figures and described in the following specification is simply an exemplary embodiment of the present invention. Hence, specific dimensions and other physical characteristics related to the embodiments disclosed herein are not to be considered as limiting.

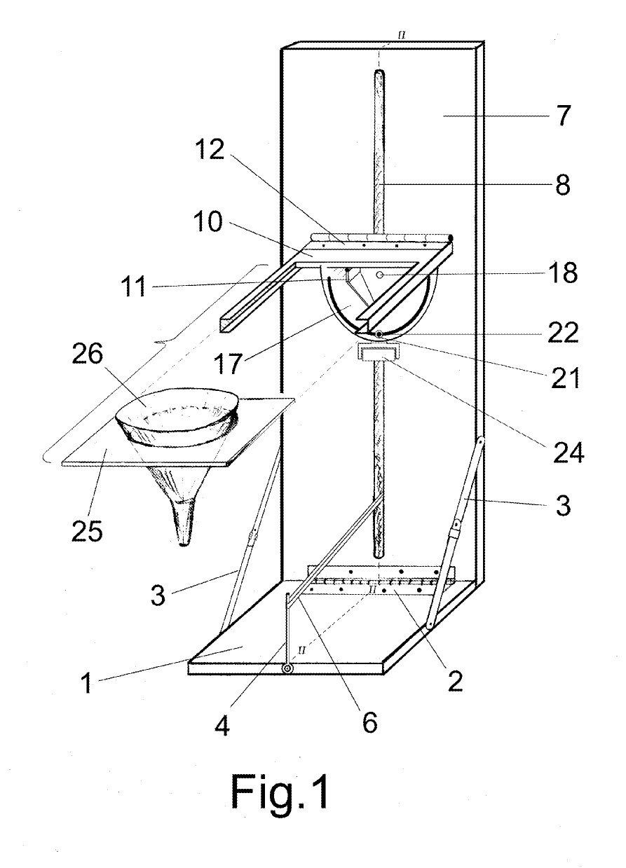

FIG. 1 depicts an embodiment of a collapsible adjusting utility stand configured as a funnel stand, including a platform base 1 attached to a vertical carrier 7 with a base hinge 2. Traveling vertically along a guide slot 8 in vertical carrier 7 is a vertical adjustment assembly, including a face plate 17, a back plate roller 24, and a holder 10 configured with grooved arms that accept a funnel support plate 25. The base can be fixed in the open position with a pair of locking hinge base braces 3. Any combination of hinge style and locking mechanism may be used that allows the base to fold against the vertical carrier and be securely fixed in the open position. The term “carrier” in this context refers to an upright member that is fixed in length while the vertical adjustment assembly moves, which serves as the primary means to guide the funnel support bracket through its range of vertical travel while maintaining the proper orientation, and is able to carry the full load of the vertical adjustment assembly and attachments.

The platform base 1 may be constructed of any solid material having varying lengths, widths, and thickness. A front stabilizer post 4 constructed of any suitably rigid material is affixed to the front center of the base 1 so that it can stand vertical or rotate ninety degrees to lie in the plane of the base 1 when not in use. An elastic band 6 can be stretched through the carrier slot 8 from a corresponding stabilizer post on the back of the carrier to stabilize the bottom of a container placed near the center of the base 1 and inside the elastic band 6. The elastic band may be constructed of any material providing the desired elasticity and frictional resistance to movement in contact with a container surface.

The vertical carrier 7 may be constructed of any solid material having varying lengths, widths, and thicknesses. The carrier slot 8 may be of any length and width depending on the range of vertical adjustment desired and the method chosen for engaging the slot 8. The vertical adjustment assembly in the illustrated embodiment engages the slot with two shafts projecting from the back of the vertical adjusting assembly, best viewed in FIG. 8.

FIG. 8 shows an adjustment shaft 15 and a guide shaft 16 attached to a back plate 9. The two shafts project through slot 8 from the front side of vertical carrier 7. The adjustment shaft 15 terminates on the back side of the vertical carrier 7 with a threaded section that accepts a large flat adjustment washer 14 and an internally threaded adjustment handle 13. Removing the adjustment handle and washer allows the user to quickly take off the vertical adjustment assembly and expose the contact surfaces between moving and fixed parts for cleaning.

When the adjustment handle 13 is tightened it compresses the adjustment washer 14 and back plate 9 against both faces of the vertical carrier 7 and locks the vertical adjusting assembly in place. Loosening the adjustment handle frees the assembly to travel lengthwise along the slot. Additional embodiments may use different release handles or grips that are simple and designed for single hand operation that employ varying means of selectively engaging the vertical carrier to fix elevation.

The back plate roller 24 contacts the front face of the vertical carrier 7 to reduce frictional resistance to vertical movement when the adjustment handle 13 is loosened. Other embodiments may employ springs that act on rollers or wheels to assist in holding the back plate away from the vertical carrier while the vertical carrier assembly moves. Design of a particular embodiment will be informed by the composition and surface textures of the materials used and the loads expected to be placed on the vertical carrier assembly during the intended application.

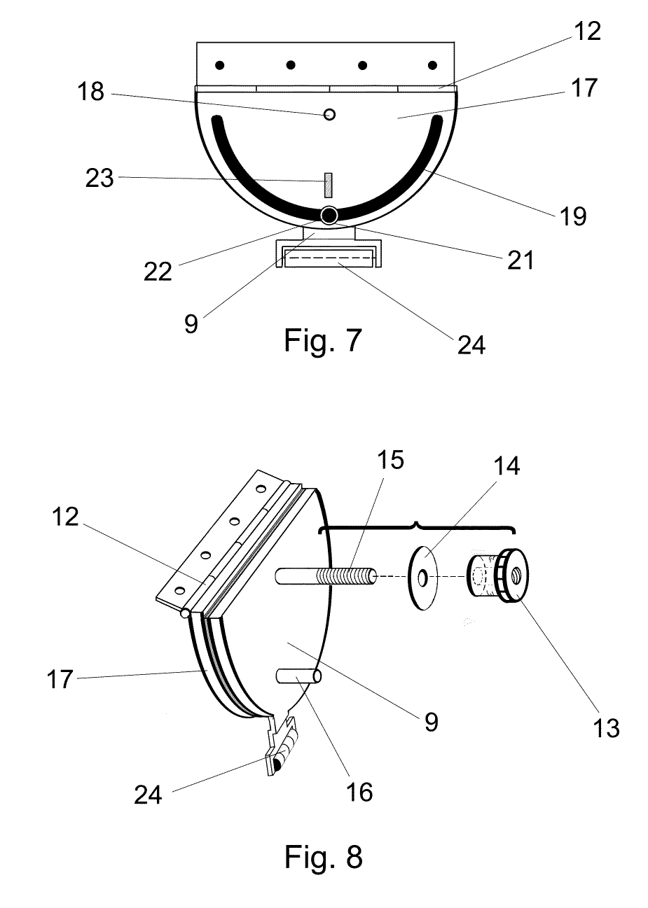

The face plate 17 is attached to the back plate 9 with a face plate pivot shaft 18, shown in FIG. 7, projecting from the front side of the back plate 9 and through the face plate 17. A threaded face plate adjustment shaft 20 also projects from the front face of the back plate and through the face plate adjustment slot 19. The face plate can rotate around the face plate pivot to adjust the orientation of the holder and be fixed in the desired position with a face plate adjustment washer 21 and face plate adjustment knob 22 that screws onto the face plate adjustment shaft 20.

If the receiving container opening does not sit parallel to its base, the face plate adjustment feature allows the funnel to sit at an angle to project into the opening and still rest in the funnel holder. With the funnel at an angle, the likelihood of spilling over the edge is greater and it becomes all the more important to have both hands free and an unobstructed view for pouring. The pivot shaft can terminate in a removable cap or cotter pin allowing the face plate to be quickly changed to a face plate configured with a holder other than a funnel support plate holder.

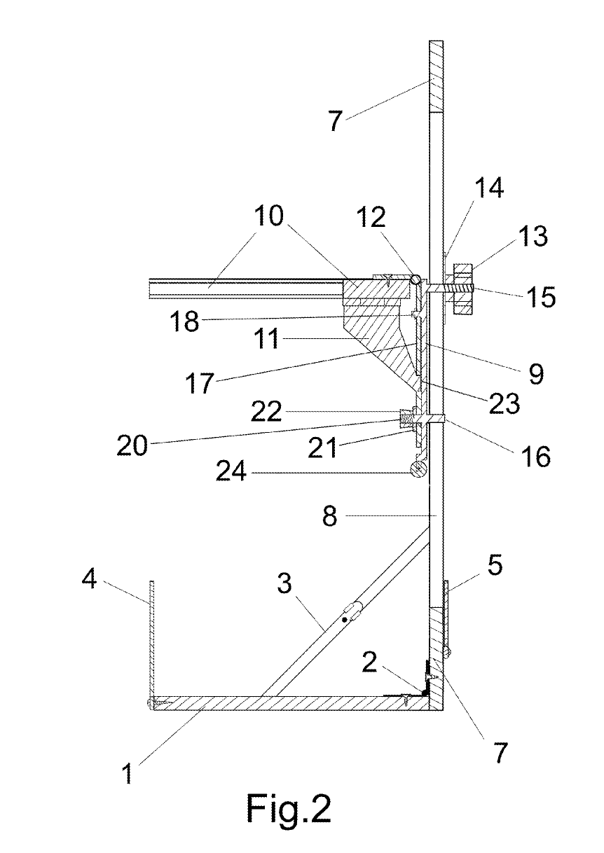

FIG. 2 shows a sectional view cut down the center of the carrier slot and base from front to back along the hashed line II in FIG. 1. The hinged holder brace 11 swings down in the open position to engage face plate brace slot 23. The length of the brace 11 is such that when opened it supports the holder 10 in a generally horizontal orientation. The holder is attached to the face plate with a holder hinge 12.

For embodiments where an orientation other than horizontal is desired, the length of the brace can be changed or made adjustable, or an alternate means for maintaining the holder at the desired position of rotation around the holder hinge can be employed. For example, an embodiment might extend the face plate above holder hinge 12 and attach a chain near the top of the face plate on either side of the holder that can engage the holder at different points along the length of the chain braces. Changing the length of the hanging braces will then allow the holder to sit at selected positions of rotation around holder hinge 12.

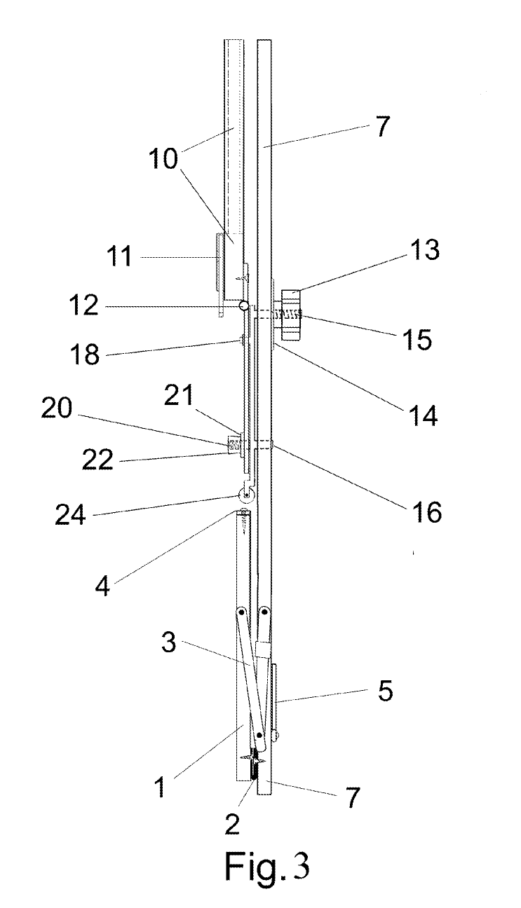

FIG. 3 shows a funnel holder embodiment of the utility stand collapsed for storage. Sliding collars on the locking hinged base braces 3 at each side release the hinged braces and allow the base 1 to fold against the vertical carrier along base hinge 2. The holder brace 11 folds against the bottom of the holder 10 and the holder hinge 12 allows the holder 10 to fold parallel to the vertical carrier 7. The base 1 also folds parallel to the vertical carrier using the base hinge 2.

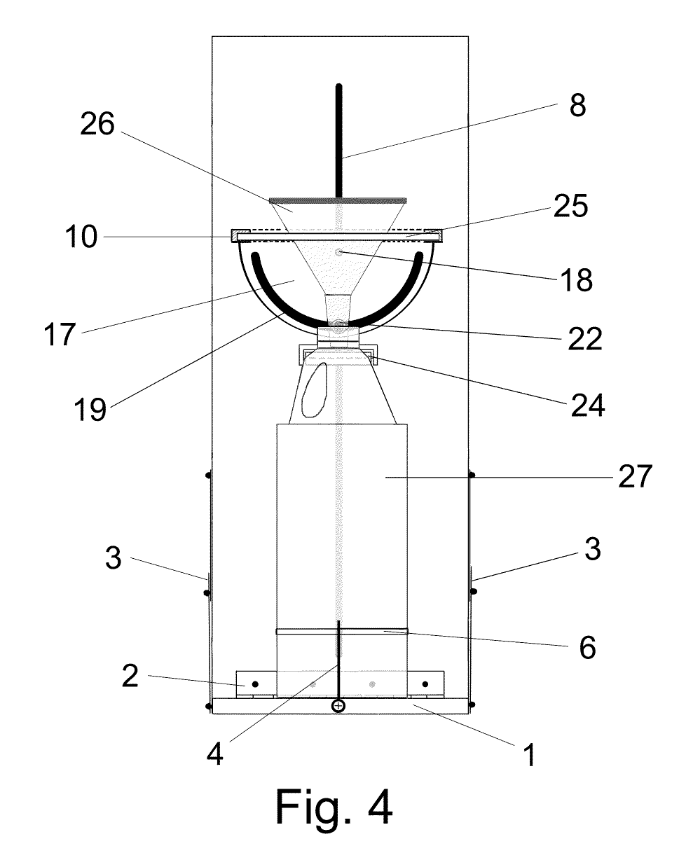

FIG. 4 shows a front view of a funnel holder embodiment of the utility stand with a funnel 26 and receiving container 27 placed inside stabilizing band 6. The funnel is installed in a support plate 25 and the plate fitted into the grooved arm projections of the holder 10. The upper rim of the grooves in the holder arm allow the funnel support plate 25 to slide for a distance from front to back while still securely supporting the funnel in a generally vertical position. The projecting arms of holder 10 can be made extensible for containers with very wide bases.

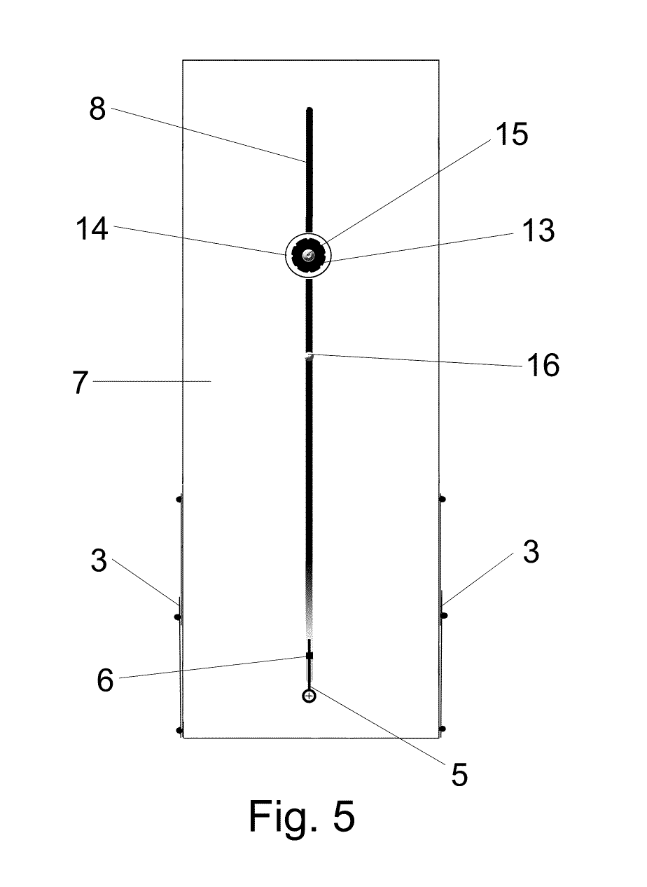

FIG. 5 shows the deployed stand of FIG. 1 from the back side. The rear stabilizer post 5 is shown with a stabilizer band 6 hooked over it. The guide shaft 16 may project out of the slot if desired and can terminate in a secondary release handle. The guide shaft at minimum need only engage the slot to limit rotation around the adjustment shaft. Other embodiments might use a single shaft elongated in cross section so that it can slide freely in a longitudinal slot while rotation around its lengthwise axis is limited.

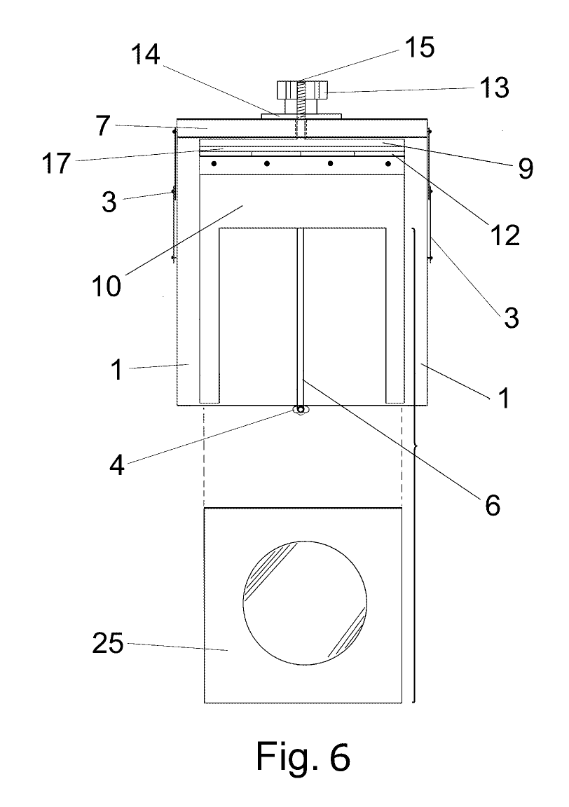

FIG. 6 depicts a top view of FIG. 1 with a funnel support plate 25 ready to install. The elastic stabilizing band is shown stretched under the center line of the holder 10 from front to back, allowing the user to slide a receiving container front to back inside the band to position it under a funnel spout. In the preferred embodiment the funnel support plates are constructed of a rigid transparent material that securely supports the funnel while minimizing visual obstruction and shading of the receiving container and funnel spout.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim:

1. A collapsible adjusting utility stand comprising:
(a) a base, including a means for stabilizing an object in position relative to said base and a hinged connection to a vertical carrier such that said base can fold parallel to said vertical carrier in the closed position and lock in the open position relative to said vertical carrier such that said vertical carrier is held in a generally upright position with the base sitting on a level surface;
(b) a vertical carrier that serves as primary support and guide for a vertical adjustment assembly while minimizing the area of surfaces in contact and frictional resistance to movement between stationary and moving surfaces; said vertical carrier comprised of a member that is fixed in length while said vertical adjustment assembly moves along it, with movement of said vertical adjustment assembly being restricted in any direction but along the length of said vertical carrier, including rotation around an axis, by interactions between said vertical adjustment assembly and said vertical carrier;
(c) a traveling vertical adjustment assembly including a release grip or handle that is simple in design and function, is not positioned over said base, and is capable of operation by a single hand to both move said vertical adjustment assembly and selectively engage with said vertical carrier to fix elevation, a hinged connection to an object holder allowing said object holder to fold parallel to said vertical carrier, and a means for changing and fixing the orientation of said object holder relative to said base; and
(d) an object holder configured to secure an object in a stable orientation, including a means for fixing said object holder in a selected position of rotation around said hinged connection to said vertical adjusting assembly such that any supporting or bracing member or members employed to fix said object holder in a selected position of rotation around said hinged connection to said vertical adjusting assembly that would extend or protrude substantially beyond said object holder in the closed position fold flat or lie parallel to said vertical carrier when in the closed position.

2. The collapsible adjusting utility stand of claim 1 wherein said object holder is configured to hold funnels.

3. The collapsible adjusting utility stand of claim 1 wherein the means for stabilizing an object in position relative to said base includes an elastic band stretched above said base.

4. The collapsible adjusting utility stand of claim 1 wherein said vertical carrier includes a longitudinal slot or slots engaged by said vertical adjusting assembly to restrict movement of said vertical adjustment assembly in directions other than along the length of said vertical carrier, including rotation around an axis.

5. The collapsible adjusting utility stand of claim 4 wherein the means of engaging said longitudinal slots in said vertical carrier assembly includes a plurality of shafts that insert into or through said longitudinal slot or slots.

6. The collapsible adjusting utility stand of claim 1 wherein said vertical carrier is extensible but fixed in length when said vertical adjustment assembly is moving.

7. The collapsible adjusting utility stand of claim 1 wherein said vertical adjustment assembly includes wheels or rollers as points of contact between said vertical carrier and said vertical adjustment assembly to reduce frictional resistance to movement and facilitate operation with one hand.

8. The vertical adjustment assembly of claim 7 wherein springs act on said wheels or rollers to assist in holding fixed and moving surfaces apart while said vertical adjustment assembly moves.

9. The collapsible adjusting utility stand of claim 1 wherein said release grip or handle comprises an adjustment handle that threads onto an adjustment shaft attached to said vertical adjustment assembly such that selectively tightening said adjustment handle compresses portions of said vertical adjustment assembly against said vertical carrier to fix elevation, and loosening said adjustment handle frees said vertical adjustment assembly to move lengthwise along said vertical carrier.

10. The collapsible adjusting utility stand of claim 1 wherein the means for changing and fixing the orientation of said object holder relative to said base includes a pivotal connection to said vertical adjusting assembly allowing said object holder to rotate around said pivotal connection and be fixed in the desired position of rotation.

11. The pivotal connection of claim 10 wherein said pivotal connection includes a removable retaining element allowing one embodiment of said object holder to be replaced by a different embodiment of an object holder also configured to mate with said pivotal connection.

12. The collapsible adjusting utility stand of claim 1 wherein the means for supporting or bracing said object holder in a selected position of rotation around said hinged connection to said vertical adjusting assembly includes a bracing member of fixed length with a hinged connection to said object holder such that said bracing member folds parallel to said vertical carrier when closed and engages a hole or slotted opening in said vertical adjusting assembly opposite the hinged end in the open position.

13. The collapsible adjusting utility stand of claim 1 wherein the means for supporting or bracing said object holder in a selected position of rotation around said hinged connection to said vertical adjusting assembly includes a bracing member or members that can be adjusted in length to change and fix the orientation of said object holder in a desired position of rotation around said hinged connection between said object holder and said vertical adjusting assembly when in the open position, and flatten parallel to said vertical carrier when in the closed position.

14. The collapsible adjusting utility stand of claim 1 wherein the means for supporting or bracing said object holder in a selected position of rotation around said hinged connection to said vertical adjusting assembly includes a hinged connection that can be selectively released to rotate and fixed in the desired position of rotation.

15. The object holder configured to hold funnels of claim 2 wherein said object holder includes a means for securing members of a set of interchangeable funnel support plates, each of said plates with a different size circular cutout so that a set of such plates can accommodate a range of funnel sizes.

16. The object holder configured to hold funnels of claim 15 wherein the means for securing said funnel support plates includes two parallel holder arms with facing grooves such that said funnel support plates slide easily in and out of said parallel grooves while said parallel grooves limit vertical movement of said funnel support plates when deployed in a horizontal orientation.

17. The object holder configured to hold funnels of claim 16 wherein said parallel holder arms are extensible.

18. The interchangeable funnel support plates of claim 15 wherein said plates are constructed of a rigid transparent material that minimizes shading and visual obstruction.
